(19) United States
(12) Patent Application Publication
(10) Pub. No.: US 2010/0310806 A1
(43) Pub. Date: Dec. 9, 2010

(54) Coating material for coating a metal surface and coated structural components and steel pipes

(76) Inventors: Paul Stoll, Olfen (DE); Hubertus Giefers, Paderborn (DE); Peter Remer, Duesseldorf (DE); Leonhard Rose, Borchen (DE)

Correspondence Address: KRIEGSMAN & KRIEGSMAN, 30 TURNPIKE ROAD, SUITE 9, SOUTHBOROUGH, MA, 01772, US

(21) Appl. No.: 12/799,586

(22) Filed: Apr. 27, 2010

(30) Foreign Application Priority Data
Apr. 27, 2009 (DE) 10 2009 019 058.9

(51) Int. Cl. C23F 11/08; B05D 3/02; B32B 1/08

(52) U.S. Cl. 428/36.91; 427/372.2; 106/14.05; 106/14.44; 106/14.39

(57) ABSTRACT

The present invention relates to a coating material in the form of a suspension for the coating of metal surfaces of components prior to a thermal treatment for protection against corrosion. The coating material is hereby characterized in that the solid phase of the suspension primarily is composed of aluminum particles, and the liquid phase is composed of organic solvents and binders, the solid phase of the suspension containing at least two types of aluminum particle shapes, which are differentiated by their specific surface. In addition, a component is described, whose metal surface has been coated with a coating material according to the invention prior to thermal treatment and which has a contact resistance of <1 mOhm (DIN EN ISO 18594) after thermal treatment.

### BACKGROUND OF THE INVENTION

The present invention relates to a coating material for protecting metal surfaces against corrosion. In particular, the coating material serves for protecting against gas corrosion in the manufacturing process of metal components or pipes and against corrosion in general during the use of the components and pipes. In addition, structural components and pipes involve steel components and steel pipes, particularly structural components and pipes for automobile manufacture, and especially for autobody construction.

Usually unalloyed or low-alloy steel types are used for such components and pipes. When unalloyed or low-alloy steel parts are subjected to thermal treatment (annealing, hardening, etc.), however, the unprotected steel surface is subjected to intense gas corrosion in an oxygen-containing atmosphere. This process is also called scaling. Since thermal treatment often takes place at temperatures above 900° C., scale formation is strongly pronounced. The scale layer that forms negatively influences the subsequent operating processes, such as, for example, hot forming, coating, welding, and similar operations. In order to avoid scale formation, today more and more steel parts that have been pre-coated are being used. The coatings often also endow the steel parts with stability not only against gas corrosion, but also against corrosion in general during the use of the steel part. The problem of increasing stability against gas corrosion and corrosion in general is still very acute, despite existing solutions. In particular, during mass production and during the use of steel parts, such as pipes or autobody components, losses of material and reductions in quality due to gas corrosion and corrosion in general are not acceptable.

For the hot forming of autobody components, the initial material is austenitized in a furnace at temperatures of 950° C., for example, over the course of 3-15 minutes. Yet even a small concentration of oxygen in the furnace leads to gas corrosion (scaling) of the surface. When the material is removed at approximately 950° C., the surface oxidizes again extremely rapidly in the air atmosphere until the hot forming mold, in which the material is hardened, is closed. Loosely adhering scale can fall off/chip off in the forming tool and dirty the hot-forming mold. The gas corrosion products on the surface of the component have very damaging effects on the quality and service life of the process tools. In addition, the scale fragments can be pressed into the newly introduced component in the subsequent forming process and can adversely affect at least the appearance of the component. The formed oxide-containing surface is also solidly or loosely adhering and has such a high contact resistance that spot welding is not possible. The scale must be removed from the surface for the further processing of autobody components. An important objective of this processing step is assuring that spot welding can be conducted in the subsequent process, which is reliably achieved only when there is a contact resistance of <1 mOhm.

The contact resistance (DIN EN ISO 18594) can serve as a guiding value for weldability. This value combines the resistances of the coated surface and of the base material. If this contact resistance is less than 1 mOhm, then spot welding is possible according to experience. In a first approximation, the contact resistance can also serve as a measurement for the protective effect or of the quality of the coating materials to be compared. The lower the contact resistance is after thermal treatment, the higher is the protective effect of the coating material (under otherwise equal conditions), particularly against corrosion in general.

The above-described problems in the production of autobody components are similar in many cases to problems in the production of steel pipes. Thus, the oxide or scale layer also acts in a damaging manner on pipe surfaces when the pipe is drawn over a mandrel, both on the forming tools as well as on the quality of the pipe. One also aims at a contact resistance of the pipe surface that is as small as possible, since the electrical conductivity of the pipe surface has a strong influence on the subsequent processing steps, such as, for example, the galvanizing process for pipes.

In order to minimize the gas corrosion of steel pipes during thermal treatment as well as to improve stability to corrosion in general, different types of protective layers are currently utilized.

A known method for coating steel surfaces is aluminizing. In the case of aluminizing, aluminum coatings are introduced onto the steel surface by plating, by means of metal spraying methods, by diffusion (alitizing) or by means of hot dipping methods. In the case of alitizing, an aluminum-rich surface layer is produced on iron and steel by annealing in contact with aluminum at temperatures of approximately 800° C. The layers produced by aluminizing usually show a good stability both against gas corrosion as well as also against corrosion in general. However, all variants of the aluminizing process are cost-intensive and are associated with additional, often complex, working steps. Also, a strip material that is fire-aluminized with an Al—Si layer can only be processed in the direct hot forming process, since the fire-aluminized layer can chip off in the deformation of the surface prior to the furnace process. Finally, specific time and temperature parameters must be precisely maintained for this process. For example, the rate of heating up to 700° C. must be less than 12° C./s, the maximum furnace temperature should not exceed 930° C., and the maximum furnace time should not exceed 13 minutes.

In addition, paint systems based on aluminum pigments are known. This type of paint system is described, for example, in DE 10 2004 049 413 A1. In this case, a layer is introduced onto a metal surface. This layer comprises hydrolysates/condensates of at least one silane or one silicone resin binding agent, as well as, optionally, a suitable solvent. In addition, it contains at least one metal filler. The coating is dried and/or hardened. Metal pigments are used, in particular, as fillers in this composition.

A disadvantage of this composition is that a metal surface coated with this composition reacts very sensitively to fluctuations of the oxidation potential in the atmosphere of a protective gas furnace. The contact resistance of the scale protective layer is usually less than 1 mOhm, if the protective gas atmosphere has a small oxygen content (<1-2%). If the oxygen concentration in the furnace exceeds these values, then the electrical resistance of the scale protective layer increases drastically above 1 mOhm, so that the resistance reaches more than 12-20 mOhms in an air atmosphere.

It has also been shown that metal surfaces coated with this composition have a strong, unacceptable tendency in that the coating material spatters during spot welding, which can be attributed to a high content of binder residues, in particular soot products and silicon compounds, in the layer.

Also, the known coating materials that are similar to paints are not suitable for coating pipes, which, for example, are to be galvanized subsequent to the thermal treatment. This problem can also be explained by the large number of binder residues containing carbon or silicon in conventional scale protection systems. These residues act in an extremely damaging manner on the adhesion of the galvanically introduced Zn layer.

The above-described prior art shows that at the present time, there are no coating materials similar to paints on the market that permit the production of scale protection layers that have contact resistance values of less than 1 mOhm (DIN EN ISO 18594) in the case of thermal treatment of steel surfaces at a temperature of up to 950° C. in a protective gas atmosphere and in an air atmosphere, or that assure in advance a spot weldability and have a marked stability against corrosion in general.

### SUMMARY OF THE INVENTION

The object of the present invention is thus to create a new coating material in order to eliminate the deficits of the prior art.

The object is solved according to a first aspect of the invention by a coating material in the form of a suspension for coating metal surfaces of components prior to the thermal treatment for protection against corrosion. The coating material is hereby characterized in that the solid phase of the suspension is primarily composed of aluminum particles, and the liquid phase is composed of organic solvents and binders, the solid phase of the suspension containing at least two types of aluminum particle shapes, which are differentiated by their specific surface.

In the sense of the present invention, a suspension is understood to mean, in particular, a heterogeneous mixture of liquid-phase and solid-phase substances, in which the solid phase is not soluble, or is only slightly soluble, in the liquid phase. The suspension according to the invention is preferably a suspension similar to a paint. Components whose metal surfaces are coated with the coating material according to the invention prior to thermal treatment are, in particular, sheet metal or pipes for the production of structural components or pipes for other fields of application. After coating with the coating material, the components are subjected to thermal treatment. The finished, thermally treated components particularly represent components for automobile manufacture, in particular structural components for autobodies and pipes. The metal surfaces are steel surfaces, in particular. It is particularly preferred that the entire component, which is to be coated with the coating material, is made of steel. One possible steel that can be used for the components is a 22MnB5 steel, which is marketed, for example, by the applicant, under the name BTR 165. Of course, other low-alloy or unalloyed steels can also be used. The metal surface is also called the steel surface in the following and the material of the component is designated as steel.

A heating or a heating up of the component with subsequent cooling or quenching is understood as the thermal treatment of a component in the sense of the present invention. Cooling or quenching can be produced in different media, such as, for example, air, liquid, or also in a mold. In the last-named case, when the component is cooled, a plastic deformation or forming can be additionally produced. This type of thermal treatment is also called hot deformation or hot forming in the following.

The specific surface of the aluminum particles, in the sense of this invention, is designated as the value of that surface which has one gram of aluminum particles. According to the invention, the solid phase primarily comprises aluminum particles, the quantity of aluminum particles in the solid phase preferably amounting to more than 91 wt. %. A binder that dissolves in the liquid phase is thus not considered to belong to the solid phase. Due to this high percentage of aluminum in the coating agent, a sufficient quantity of aluminum can be introduced onto the metal surface, particularly the steel surface, and this will protect against corrosion even when only small amounts are applied. Also, reactions of the other components or their effect on reactions of the aluminum with the iron of the steel can be minimized by the small percentage of other components in the solid phase. The other components of the solid phase can be added in a targeted manner in order to cause specific, desired reactions and to influence reactions. In the case of the coating material according to the invention, the solid phase preferably represents between 15 and 30 wt. % of the suspension. Here, binders that dissolve in the liquid phase are thus not considered to belong to the solid phase.

Since aluminum particles are used in shape types with different specific surfaces, consideration can be given to the requirements for the aluminum in the further treatment and the use of a component produced or being produced from the component onto which the coating material is applied. On the one hand, a sufficient quantity of aluminum can be made available in the coating material in order to produce an optimal, preferably closed, diffusion layer in the metal surface. A type of aluminum particle shape can also equally be used that improves the ease of application of the coating material. The diffusion layer, which represents the scale protection layer according to the present invention, is formed during the thermal treatment of the component coated with the coating material. The aluminum diffuses from the solid phase into the steel surface and forms an Al—Fe diffusion layer with the iron of the steel in the surface.

In addition, according to the invention, the binder and the solvent of the suspension are organic agents. The coating material according to the invention, which is based on organic solvents, for example, such as alcohol or alcohol-hydrocarbon mixtures, preferably contains carbon-based synthetic, or more preferably, natural resins or resin derivatives as the binder (for example, rosin or rosin-glycerol esters). The named resins, which contain metal particles on the metal surface, in particular the steel surface, can be burned/vaporized with as little residue as possible in the furnace process.

According to one embodiment, the aluminum particles are composed of pure aluminum with an aluminum content of 98.0-99.9%. The formation of a diffusion layer in the metal surface is favored due to this high percentage of aluminum. In addition, a targeted, partial oxidation of a portion of the aluminum particles can be assured also when there is a high percentage. This oxidation of a portion of the aluminum particles can also lead to the circumstance that these particles serve as a “sacrificial offering” and prevent the oxidation of additional aluminum particles.

According to a preferred embodiment, one of the aluminum particle shapes is a spherical shape or a granular shape. An irregular particle shape is called a granular shape. The granular-shaped particles, for example, can represent oval or drop-shaped particles. Additionally or alternatively, the surface can also be irregular in the case of granular-shaped particles.

It has been shown surprisingly that by using spherical-shaped or granular-shaped particles as at least one type of aluminum particle shape in the suspension of the coating material, based on the favorable volume/surface ratio of spheres and granules, the aluminum particles essentially oxidize less and thus more aluminum passes over into the diffusion layer or protective layer.

When aluminum particles with a smaller volume/surface ratio are used exclusively, i.e., with a larger specific surface, which is present, for example, in aluminum pigments, in which the aluminum particles are present as chips or flakes, in contrast, such a protective layer cannot be formed or it can only be formed inadequately. In particular, a coating material in which aluminum particles are present exclusively in the shape of pigments or flakes can only be used conditionally as protection against corrosion in general. The reason for this is the lack of good adherence or metallurgical bonding between the aluminum pigments and the steel surface. The pigments (Al flakes) have a very large specific surface. Thus, the ratio between volume (pure aluminum) and the already oxidized surface of the pigment particles is very small. The pure aluminum, which is available in too small a concentration cannot form a highly concentrated diffusion layer with respect to the aluminum content, based on the fact that there are too many diffusion barriers, which are formed by contact surfaces of the Al flakes. When aluminum pigments are heated up in an oxygen-containing atmosphere, the particles oxidize again and thus increasingly adversely affect the adhesion as well as the conditions for the formation of the Al—Fe diffusion layer. This is shown by the presence of an aluminum-iron diffusion layer that has formed and that is not closed. Only point-like diffusion bridges are formed.

This is shown in FIGS. 3a and 3b. In these figures are shown cross sections of sheet metal composed of BTR165 with a coating applied by an Al spray comprising Al flakes and organic solvents and binders (FIG. 3a) and with a coating applied with a paint system comprising Al flakes and organic/inorganic hybrid polymer binders and organic solvents (FIG. 3b) after thermal treatment in a protective gas furnace with an oxygen content of <5%, a temperature of 950° C. and a treatment time of four minutes. The white places that can be recognized on the surface of the sheet metal in the figures are the diffusion bridges formed by the aluminum.

With the use of a coating material, in which at least a portion of the aluminum particles in the solid phase of the suspension have a spherical or granular shape, there results an essentially smaller oxidation due to the smaller specific surface, and consequently more aluminum passes over into the diffusion or protective layer. The spherical or granular aluminum particles in this sense possess specific self-protection properties and thus show a “self-protection effect” of the aluminum particles.

The spherical or granular aluminum particles in the solid phase of the suspension most preferably have a specific surface in the range of 0.05 to 0.50 m²/g, preferably in the range of 0.15 to 0.35 m²/g. The above-named self-protective effect can be obtained particularly reliably with particles having these specific surfaces. In particular, contact resistance values of <1 mOhm (DIN EN ISO 18594) can be obtained with particles having these specific surfaces and simultaneously a good ease of application and reproducibility of the results can be achieved with particles having a specific surface in the preferred range.

Preferably, 60 to 90 wt. % of the aluminum particles in the solid phase of the suspension are present as spherical particles and/or in the shape of granular particles. Due to this percentage, a sufficient quantity of pure aluminum, particularly unoxidized aluminum, can be made available for the formation of the diffusion layer. Also, the ease of application of the coating material onto a metal surface will not be adversely affected by this percentage of spherical or granular particle shapes, which might otherwise be the case with a higher percentage of this type of aluminum particle shape.

According to another embodiment, a chip shape represents one of the shape types. As described above, the use of aluminum particles in chip shape alone, i.e., as flakes or pigments is disadvantageous. The presence of the chip-shaped particles can be utilized advantageously, of course, by combining the chip-shaped particles with particles of another shape as provided according to the invention. The chip-shaped particles are particularly preferably combined with another type of aluminum particle shapes that possess a smaller specific surface.

After they are applied onto the metal surface, due to their shape, the chip-shaped particles partially float on the surface of the applied coating material. They are subjected there to the surrounding atmosphere and oxidize particularly due to the oxygen content in the atmosphere. The chip-shaped particles thus serve in part as a “sacrificial offering” and protect the particles of the solid phase of the coating material lying underneath them.

Also, the ease of application of the suspension onto the metal surface is improved by the combination of chip-shaped particles with other particles.

Preferably, the chip-shaped aluminum particles have a specific surface in the range of 1 to 8 m²/g, preferably in the range of 1.2 to 5.4 m²/g. The inventors of the present invention have discovered that the above-described self-protective effect is shown to be strongest with these values. The specific surface of the chip-shaped aluminum particles or aluminum flakes in the coating material is preferably smaller than 8 m²/g, since otherwise the allowable concentration of aluminum flakes in the solid phase may not be higher than 5-7 wt. %. A higher percentage by weight of aluminum flakes is necessary, of course, in order to be able to optimally adjust the properties of the protective layer.

According to a preferred embodiment, 10 to 40 wt. % of the aluminum particles in the suspension are present as chip-shaped aluminum particles, so-called aluminum flakes. The ease of application of the coating material deteriorates when a smaller content of <10 wt. % of chip-shaped aluminum flakes is present in the suspension. In contrast, when too high a content of >40 wt. % of chip-shaped aluminum flakes is present in the suspension, not enough pure aluminum is available for the formation of an ideal diffusion layer in the metal surface.

According to one embodiment, in addition to the aluminum particles, the solid phase contains at least one non-electrically-conducting microscale or nanoscale oxide of a transition metal. In particular, microscale or nanoscale oxides of yttrium and/or Cr (III) are preferred. It has been surprisingly found that by the addition of non-electrically-conducting microscale/nanoscale oxides of yttrium and/or Cr (III) into the solid phase, a coating material can be created that is effective against gas corrosion not only in a protective gas atmosphere, but also in an air atmosphere, and the specified electrical conductivity of the scale protection layer is assured. It has been found that contact resistance values of clearly less than 1 mOhm for the scale protection layer can be achieved when heating up in a protective gas atmosphere as well as in an air atmosphere, due to the presence of the indicated oxides in the coating material.

According to one embodiment, the non-electrically-conducting microscale/nanoscale oxides of the one or more transition metals, in particular of yttrium and/or Cr (III), are present in an amount of 0.1 to 4 wt. %. Also, the size of these oxides is preferably smaller than 1 μm. At this concentration and with this size of the oxide particles, the effects can be particularly reliably obtained that the coating material is effective against gas corrosion not only in a protective gas atmosphere, but also in an air atmosphere, and that the specified electrical conductivity of the scale protection layer is assured.

According to one embodiment, additionally or alternatively to the named oxides, the solid phase may also contain titanium particles. With this measure, the self-protection effect of the two types of aluminum particle shapes can be improved and stabilized. The presence of Ti particles in the solid phase of the coating material reduces the contact resistance of the scale protection layer by a factor of 2 to 3 during heating up in a nitrogen atmosphere. The positive effect of the titanium is associated with the fact that titanium is an effective getter and has a high affinity to carbon. Therefore, titanium reduces or eliminates the damaging effect of decomposition products of the binder of the liquid phase of the suspension by the formation of corresponding oxycarbonitrides in the scale protection layer. In particular, the damaging effect of gases, binder residues, and particularly soot products, is reduced relative to the adhesion, the wetting, and the diffusion of aluminum on the metal surface. Preferably, titanium particles are added in an amount in the range of 0 to 5 wt. % referred to the solid phase of the suspension. The particle size of the titanium particles is preferably <45 μm.

According to another embodiment, the binder represents resins containing little soot, in particular natural resins. In this embodiment, an addition of titanium or other soot binders may optionally be omitted.

According to another aspect, the invention relates to a component that has been coated with a coating material according to the invention prior to thermal treatment and has a contact resistance of <1 mOhm after thermal treatment.

The component is particularly a structural component for the autobody of motor vehicles or a pipe. In this case, structural components may be produced from sheet metal and/or pipes.

The application of the coating material can be carried out on the strip prior to the cutting of sheet bars by coating the strip in a device provided expressly therefor prior to straightening. The application can also be made on punched-out sheet bars. In the case of indirectly hot-formed components, the application can be made after the pre-forming of the sheet bars.

Pipes can be coated by dipping or by means of a special application device.

For applying the coating material according to the invention, the metal surface should be free of grease and oil, so that the paint-like suspension can completely wet the steel surface. For this purpose, an oil-free strip can be prepared and coated, or the punched-out sheet bars, which come into contact with oil in the punching-out operation, are degreased by suitable measures to remove the oil.

The coating material according to the invention is dried on the metal surface at room temperature or at slightly elevated temperatures of up to 60° C.

With the present invention, a coating material is particularly created for the protection of steel pipes and steel structural components against gas corrosion during the manufacturing process in automobile construction and against corrosion in general during the application of these components; this coating material also guarantees contact resistance values for the scale protection layer of less than 1 mOhm after thermal treatment at a temperature of up to 950° both in a protective gas atmosphere as well as in an air atmosphere and assures spot weldability as well as coatability in the subsequent process steps.

Essential points of the invention or embodiments are, in particular:

A coating material in the form of a paint-like suspension, whose solid phase predominantly comprises aluminum and whose liquid phase comprises organic solvents and binders, the solid phase of the suspension containing at least two types of aluminum particle shapes, which are differentiated by their specific surface. Preferably, 60 to 90 wt. % of the aluminum in the coating material is present as spherical particles or in a granular (irregular) particle shape and has a specific surface of 0.05 to 0.50 m²/g, preferably 0.15 to 0.35 m²/g. Preferably, 10 to 40 wt. % of the aluminum is present as chip-shaped particles (Al flakes) and has a specific surface of less than 8 m²/g, preferably 1.2 to 5.4 m²/g. The solid phase of the suspension preferably can also contain microscale/nanoscale oxides of yttrium or chromium (III) or a mixture of these oxides of 0.1 to 4 wt. % and/or titanium particles of 0 to 5 wt. %. Preferably, the binder in the coating material should comprise resins that contain as little soot as possible, for example, natural resins.

The coating material that is applied and dried on a steel surface reduces gas corrosion and thus prevents the scaling of the steel surface in the furnace having an oxygen-containing atmosphere (including an air atmosphere), and after the thermal treatment of pipes or after the hot-forming process of the sheet metal into autobody components for motor vehicles, forms a stable protective layer against corrosion in general. The protective layer that forms in this case has a surface contact resistance that assures the specified spot weldability.

Unlike known paint-like systems, where a protective effect of the binder plays a decisive role, in the case of the present invention, a “self-protective effect” of the solid phase of the coating material is used for the most part.

### BRIEF DESCRIPTION OF THE DRAWINGS

The invention will be described again in the following on the basis of examples with reference to the appended figures. Here:

FIG. 1: shows curve plots of the contact resistance as a function of the weight percentage of types of Al particle shapes in the suspension;

FIG. 2: shows a cross section of a sheet metal coated with the coating material according to the invention; and

FIG. 3: shows cross sections of sheet metals with coating materials according to the prior art.

### DETAILED DESCRIPTION OF THE INVENTION

By applying onto a steel surface approximately 13 g/m² of granular/spherical (irregular) Al particles with a specific surface of approximately 0.27 m²/g (particle size of approximately 7-15 μm) in the form of a suspension based on ethanol containing cellulose nitrate or containing rosin as a binder, it is surprisingly possible to successfully produce a scale protection layer with a contact resistance of approximately 1 mOhm. By applying the same quantity of Al pigments (Al flakes) with a particle size of approximately 15 μm and with a specific surface of approximately 5.4 m²/g under the same conditions, a contact resistance of more than 17 mOhm resulted after thermal treatment. This result shows that the granular or spherical Al particles oxidize to an essentially lesser extent because of their favorable volume/surface ratio in comparison to Al pigments (Al flakes), and consequently more aluminum passes over into the diffusion or protective layer. In this sense, they possess specific self-protective properties and thus the above-described “self-protective effect” of the aluminum particles can be seen under the above-described conditions. This is also confirmed by the fact that the cellulose nitrate is a strong oxidation agent and decomposes during the heating up of the steel surface, even at a temperature below 180° C. For these reasons, a protective effect of the cellulose nitrate as a binder is excluded during the formation of the scale protection layer.

It was also found that the “self-protective effect” can be clearly reinforced with an optimal combination of granular/spherical Al particles and Al pigments (Al flakes) in the coating material.

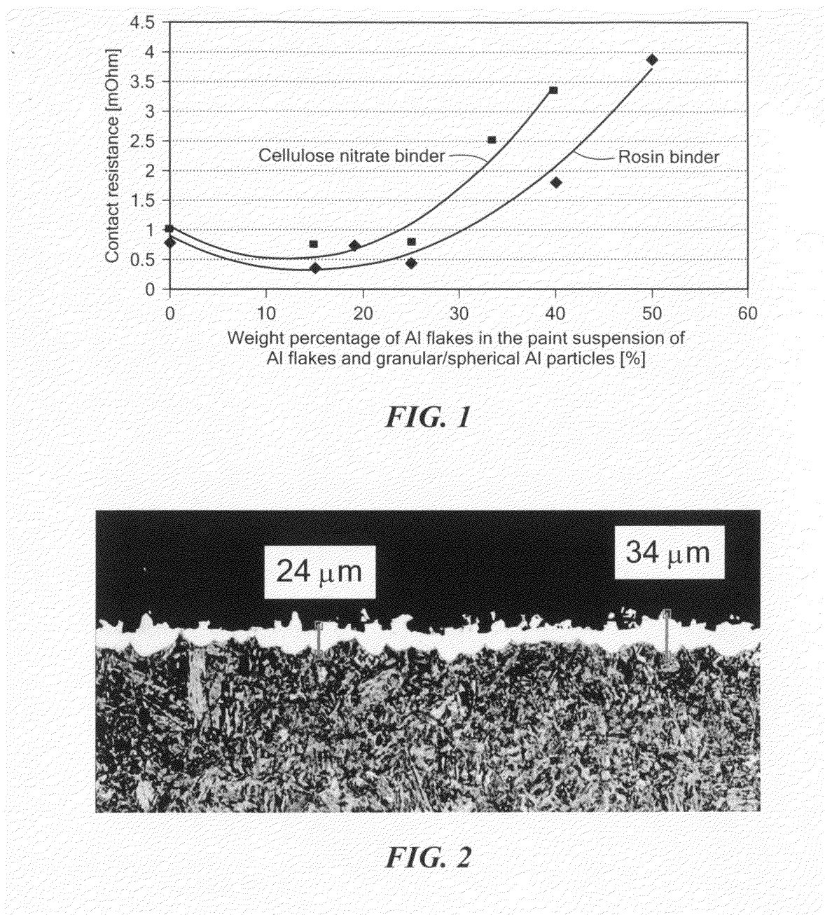

The influence of the Al pigments and of the binder in the coating material on the contact resistance is shown in FIG. 1. Here, sheets of BTR165 were coated with coating materials according to the invention and subsequently were subjected to a thermal treatment in a protective gas furnace with an oxygen content of <5%, a temperature of 950° C. and a treatment time of four minutes. Coating materials with different weight percentages of Al flakes and granular/spherical Al particles were used. In addition, different binders were also used.

As can be seen from FIG. 1, the slope of the curves depends on the oxidation potential of the furnace atmosphere, the specific surface of the Al flakes and the type of binder in the coating material. The following applies for the same test conditions: the smaller the specific surface of the Al flakes is and the less soot a binder forms during pyrolytic decomposition, the smaller is the slope of the curve. For this reason, in the present invention, one aims at utilizing binders that will form as little soot as possible during thermal treatment.

When the specific surface of the spherical/granular (irregular) Al particles in the coating material is changed, but with a constant value of the specific surface of the Al flakes, the curves shift along the Y-axis in FIG. 1. The contact resistance values of the scale protection layer are reduced when there is a small specific surface of the Al particles in the coating material. With increasing specific surface of the Al particles and a corresponding reduction of the particle size, in contrast, the curves shift to greater contact resistance values. Investigations have shown that contact resistance values of the scale protection layer of less than 1 mOhm can be obtained if the specific surface of the spherical/granular (irregular) Al particles in the coating material lies in a range of approximately 0.05 to approximately 0.50 m²/g. Taking into consideration the ease of application as well as the reproducibility of the results obtained, the preferred range is from 0.15 to 0.35 m²/g.

Several embodiment examples of the present invention are described in the following:

### Example 1

40 g of rosin were dissolved in 1000 ml of isopropanol. 230 g of granular/spherical Al particles (aluminum content of 99.5%) with a specific surface of approximately 0.27 m²/g, 50 g of Al pigments (Al flakes, aluminum content of 99.5%) of the company Benda Lutz Werke GmbH with a specific surface of approximately 5.4 m²/g and 8 g of yttrium oxide particles (particle size of ≦1 μm) were placed in the prepared solution and homogenized.

Degreased sheets of BTR165 were coated with this paint-like system by dipping and then dried in air for approximately 40 s. The covering amounted to approximately 20 g/m². Thereafter, these sheets were thermally treated in a furnace at 950° C. and 4 minutes of furnace time. The contact resistance of the coated sheets after heating in a protective gas atmosphere (oxygen content of <5%) amounted to approximately 0.30 mOhm and 0.77 mOhm after heating in an air atmosphere. The coated sheets showed a good spot weldability as well as excellent CDL paintability.

A comparison measurement with respect to general corrosion stability by means of the salt spray test showed a clear improvement (by a factor of three) of the corrosion stability when compared to conventional scale protection systems (aluminum spray comprising Al flakes and organic solvents and binders and a paint system comprising Al flakes and organic/inorganic hybrid polymer binders and organic solvents).

### Example 2

50 g of rosin-glycerol ester were dissolved in a mixture of 800 ml of isopropanol and 200 ml of gasoline (boiling point >140° C.). 180 g of granular/spherical Al particles (aluminum content of 99.5%) with a specific surface of approximately 0.15 m²/g, 70 g of aluminum pigments (Al flakes, aluminum content of 99.5%) with a specific surface of approximately 1.2 m²/g and 0.7 g of Cr (III) oxide nanoparticles (particle size of approximately 60 nm) were placed in the prepared solution and homogenized.

Degreased sheets of BTR165 were coated with this paint-like system by dipping and dried in air for approximately 40 s. In this case, the covering amounted to approximately 28 g/m². Thereafter, these sheets were thermally treated in a furnace at 950° C. and 4 minutes of furnace time. After heating in a protective gas atmosphere (oxygen content of <5%), the contact resistance of the coated sheets amounted to approximately 0.48 mOhm. The coated sheets showed a good spot weldability as well as excellent CDL paintability.

A comparison measurement with respect to general corrosion stability by means of the salt spray test showed an improvement by a factor of two when compared to conventional scale protection systems (aluminum spray comprising Al flakes and organic solvents and binders and a paint system comprising Al flakes and organic/inorganic hybrid polymer binders and organic solvents).

### Example 3

600 ml of ethanol were mixed with 400 ml of “MetCoat” sample protective paint (contains binder in the form of a mixture of organic, carbon-based polymers) of the company Bühler GmbH. 170 g of granular/spherical Al particles (aluminum content of 99.5%) with a specific surface of approximately 0.35 m²/g, 100 g of aluminum pigments (Al flakes, aluminum content of 99.5%) of the company Benda Lutz Werke GmbH with a specific surface of approximately 8 m²/g and 10 g of titanium particles (titanium content of 99.9%, particle size of 5 45 μm) were placed in the prepared solution and homogenized.

Degreased, cold-drawn pipes with an outer diameter of 15 mm of St52 steel were coated externally with this paint-like system in a specially manufactured continuous application device and dried by means of hot air. In this case, the coating amounted to approximately 23 g/m². The coated pipes were normalized in a protective gas furnace (880° C., 4 min).

Al—Fe diffusion layers are susceptible to red rust despite their corrosion-inhibiting properties. In order to eliminate this, the pipes coated and normalized in this way in a continuous plant were additionally galvanized by means of conventional technology. In this way, the scale protection layer produced according to the invention served as a primary layer for the galvanically applied Zn coating.

A comparison measurement with respect to general corrosion stability by means of the salt spray test showed an improvement of the corrosion stability by a factor of 1.5 when compared to conventionally galvanized pipes.

### Example 4

40 g of rosin were dissolved in a mixture of 500 ml of isopropanol and 500 ml of ethanol. 200 g of granular/spherical Al particles (aluminum content of 99.5%) with a specific surface of approximately 0.27 m²/g, 60 g of aluminum pigments (Al flakes, aluminum content of 99.5%) of the company Benda Lutz Werke GmbH with a specific surface of approximately 3.4 m²/g, 12 g of titanium particles (titanium content of 99.9%, particle size of approximately 10 μm), 1 g of Cr (III) oxide nanoparticles (particle size of approximately 60 nm) and 8 g of yttrium oxide particles (particle size of ≦1 μm) were placed in the prepared solution and homogenized.

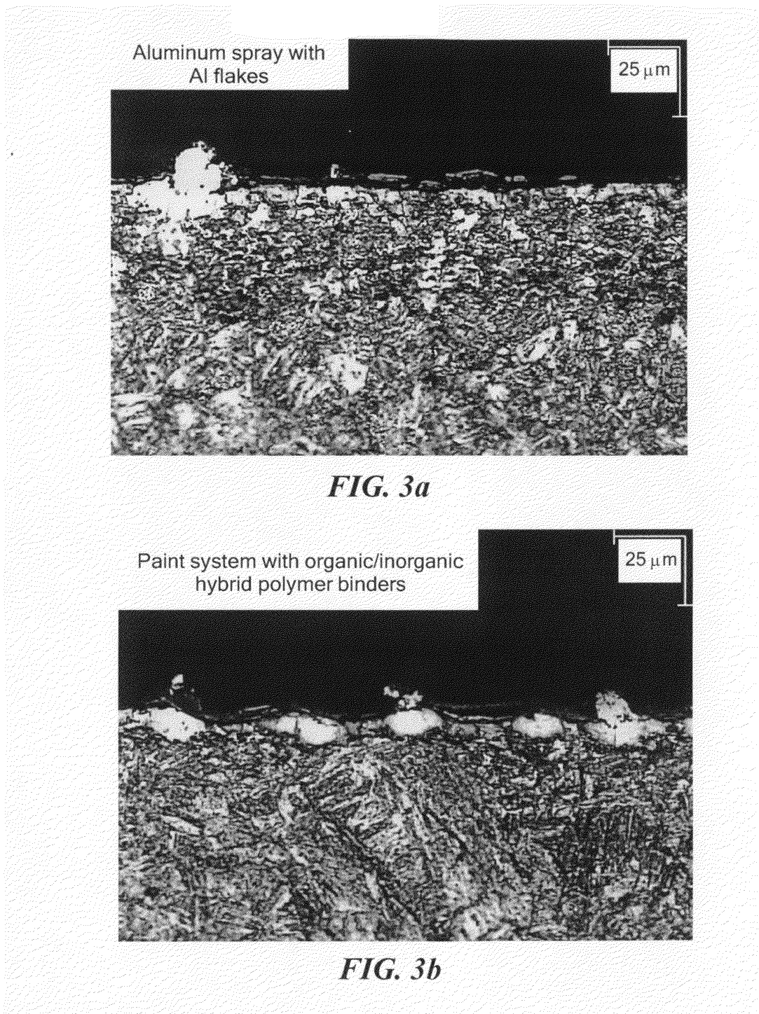

Degreased sheets of BTR165 were coated with this paint-like system by dipping and dried in air for approximately 40 s. The covering amounted to approximately 21 g/m². Thereafter, these sheets were thermally treated in a furnace at 950° C. and 4 minutes of furnace time. The contact resistance of the coated sheets amounted to approximately 0.28 mOhm after heating in a protective gas atmosphere (oxygen content of <5%) and 0.86 mOhm after heating in an air atmosphere. The coated sheets showed a good spot weldability as well as excellent CDL paintability. A section through the sample after the thermal treatment shows a nearly closed diffusion layer (see FIG. 2). Thus, the surface is better protected against corrosion in general than such layers according to the prior art, which are shown in FIG. 3. The diffusion layer, which is shown in FIG. 2 and was produced by use of the coating material according to the invention, is uninterrupted and has a depth of up to 34 μm.

A comparison measurement with respect to general corrosion stability by means of the salt spray test showed an improvement by a factor of three to four when compared to conventional scale protection systems (aluminum spray comprising Al flakes and organic solvents and binders and a paint system comprising Al flakes and organic/inorganic hybrid polymer binders and organic solvents).

The present invention has a number of advantages. The paint-like suspension is more cost-effective in price per unit of surface of coated material than the paint-like systems known from the prior art. Also, the component coated according to the invention, like the fire-aluminized layer, has corrosion protection after hot forming. By coating punched-out sheet bars, the application of the paint-like suspension can be reduced to a minimum as compared to a strip coating. The paint-like suspension according to the invention for the most part only contains environmentally compatible solvents, such as isopropanol, for example. In this way, risks that occur in the case of known coating agents, which contain large quantities of substances harmful to health and which evaporate during the drying of the layer in a furnace, can be avoided. Hot-formed components or pipes with the scale protection produced by the coating material according to the invention can also be spot-welded even without removal of the layer.

In comparison to the fire-aluminized layer, the coating proposed according to the invention does not chip off after drying on the surface, even when the sheet is pre-formed (indirect hot forming).

What is claimed is:

1. A coating material in the form of a suspension for the coating of metal surfaces of components prior to a thermal treatment for protection against corrosion, hereby characterized in that the solid phase of the suspension primarily is composed of aluminum particles, and the liquid phase is composed of organic solvents and binders, the solid phase of the suspension containing at least two types of aluminum particle shapes, which are differentiated by their specific surface.

2. The coating material according to claim 1, further characterized in that the aluminum particles comprise pure aluminum with an aluminum content of 98.0-99.9%.

3. The coating material according to claim 1, further characterized in that one of the shape types is a spherical shape or a granular shape.

4. The coating material according to claim 3, further characterized in that the spherical-shaped or granular-shaped aluminum particles have a specific surface of 0.05 to 0.50 m²/g, preferably 0.15 to 0.35 m²/g.

5. The coating material according to claim 1, further characterized in that 60 to 90 wt. % of the aluminum particles in the solid phase of the suspension are present as spherical particles and/or in granular particle shape.

6. The coating material according to claim 1, further characterized in that one of the shape types is a chip shape.

7. The coating material according to claim 6, further characterized in that the chip-shaped aluminum particles have a specific surface of 1 to 8 m²/g, preferably of 1.2 to 5.4 m²/g.

8. The coating material according to claim 1, further characterized in that 10 to 40 wt. % of the aluminum particles in the suspension are present as chip-shaped particles (Al flakes).

9. The coating material according to claim 1, further characterized in that the solid phase of the suspension has at least one non-electrically-conducting microscale or nanoscale oxide of a transition metal, in particular yttrium and/or Cr (III).

10. The coating material according to claim 9, further characterized in that the oxides are present in a quantity in the range of 0.1 to 4 wt. %.

11. The coating material according to claim 1, further characterized in that the solid phase contains titanium particles, particularly in a quantity in the range of 0 to 5 wt. %.

12. The coating material according to claim 1, further characterized in that the binder and/or the solvent of the suspension are organic agents.

13. The coating material according to claim 12, further characterized in that the binder is a resin containing little soot, in particular natural resin.

14. A component, in particular a structural component or a pipe, whose metal surface has been coated with a coating material according to one of claims 1 to 13 prior to thermal treatment and which has a contact resistance of <1 mOhm (DIN EN ISO 18594) after thermal treatment.
